(19) United States
(12) Patent Application Publication
(10) Pub. No.: US 2022/0347971 A1
(43) Pub. Date: Nov. 3, 2022

(54) Gypsum Board Including a Laminate Layer

(71) Applicant: Gold Bond Building Products, LLC, Charlotte, NC (US)

(72) Inventors: Bradley J. Busche, Shelby, NC (US); Michael Blades, Indian Land, SC (US); Joseph J. Bailey, Charlotte, NC (US)

(21) Appl. No.: 17/731,331

(22) Filed: Apr. 28, 2022

Related U.S. Application Data
(60) Provisional application No. 63/182,043, filed on Apr. 30, 2021.

(51) Int. Cl. B32B 13/06; B32B 7/022; B32B 17/06; B32B 13/12; B32B 27/20; B32B 15/20; B32B 15/18; B32B 23/04; B32B 27/30; B32B 25/08; B32B 15/06; B32B 7/12; B32B 15/04; B32B 27/06; B32B 5/18; B32B 37/24

(52) U.S. Cl. CPC B32B 13/06; B32B 7/022; B32B 17/06; B32B 13/12; B32B 27/20; B32B 15/20; B32B 15/18; B32B 23/04; B32B 27/308; B32B 25/08; B32B 15/06; B32B 17/063; B32B 7/12; B32B 17/066; B32B 15/046; B32B 27/065; B32B 5/18; B32B 37/24; B32B 2307/54; B32B 2260/021; B32B 2260/046; B32B 2262/106; B32B 2307/102; B32B 2419/00; B32B 2250/40

(57) ABSTRACT

The present invention is directed to a gypsum board and a method of making such gypsum board. In one embodiment, the gypsum board comprises a gypsum core including a first gypsum core layer and a second gypsum core layer sandwiching a laminate layer. The laminate layer comprises two outer laminate layers sandwiching an inner laminate layer, wherein the two outer laminate layers have a higher elastic modulus than the inner laminate layer. The method of making the gypsum board includes steps of providing facing materials and corresponding gypsum slurries wherein the laminate layer is provided in-line during the manufacturing process of the gypsum board.

### CROSS-REFERENCE TO RELATED APPLICATION

The present application claims filing benefit of U.S. Provisional Patent Application Ser. No. 63/182,043 having a filing date of Apr. 30, 2021, and which is incorporated herein by reference in its entirety.

### BACKGROUND

A building is typically constructed with walls having a frame comprising vertically oriented studs connected by horizontally oriented top and bottom plates or tracks. The walls often include one or more gypsum boards fastened to the studs and/or plates on each side of the frame or, particularly for exterior walls, one or more gypsum boards fastened to the studs and/or plates on one side of the frame with a non-gypsum-based sheathing attached to an exterior side of the frame. A ceiling of the building may also include one or more gypsum boards oriented horizontally and fastened to joists, studs, or other structural members extending horizontally in the building. Walls and ceilings of this construction often have poor acoustical performance and a low sound transmission class (STC) rating, which results in noise pollution, lack of privacy, and similar issues in the various spaces of the building. One of the aspects of this poor performance is the coincidence between the human voice Hertz spectrum and the vibrational Hertz range of standard gypsum board, which creates a unique dip in the acoustical curve of a standard frame and gypsum board wall.

While boards currently exist that provide sound damping, there is still a need to further improve the acoustical performance of the boards and provide improved sound damping.

### SUMMARY OF THE INVENTION

In accordance with one embodiment of the present invention, a gypsum board is disclosed. The gypsum board comprises a gypsum core including a first gypsum core layer and a second gypsum core layer sandwiching a laminate layer. The laminate layer comprises two outer laminate layers sandwiching an inner laminate layer, wherein the two outer laminate layers have a higher elastic modulus than the inner laminate layer.

In accordance with another embodiment of the present invention, a method of making a gypsum board is disclosed. The method comprises: providing a first facing material, depositing a first gypsum slurry onto the first facing material, providing a laminate layer onto the first gypsum slurry, depositing a second gypsum slurry onto the laminate layer, providing a second facing material onto the second gypsum slurry, and allowing the calcium sulfate hemihydrate to react with the water to convert the calcium sulfate hemihydrate into a matrix of calcium sulfate dihydrate.

In accordance with another embodiment of the present invention, a gypsum board is disclosed. The gypsum board comprises a gypsum core including a first gypsum core layer and a laminate layer on the first gypsum core layer. The laminate layer may comprise two outer laminate layers sandwiching an inner laminate layer, wherein the two outer laminate layers have a higher elastic modulus than the inner laminate layer.

### BRIEF DESCRIPTION OF THE DRAWINGS

The invention will now be described, by way of example, with reference to the accompanying drawings, in which:

FIGS. 1-2 illustrate cross-sections of various embodiments of a gypsum board according to the present invention;

FIG. 3 illustrates a cross-section of another embodiment of a gypsum board according to the present invention; and

FIG. 4 illustrates a cross-section of another laminate layer according to the present invention.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum board and a method of making such gypsum board. In particular, in one embodiment, the present invention is directed to a gypsum board including a gypsum core having a laminate layer provided therein. In another embodiment, the present invention is directed to a gypsum board including a gypsum layer and a laminate layer provided thereon. In particular, the laminate layer is composed of materials having certain properties. The present inventors have discovered that by providing a laminate layer as disclosed herein, various advantages may be realized.

For instance, the present inventors have discovered that the laminate layer as disclosed herein may be effective in improving the acoustical performance of the gypsum board thereby minimizing the transmission of noise through a wall containing such gypsum boards. For instance, in comparison to conventional gypsum board, in particular an existing, installed gypsum board without a laminate layer, the gypsum board as disclosed herein may exhibit a sound transmission loss of 5% or more, such as 10% or more, such as 15% or more, such as 20% or more, such as 25% or more, such as 30% or more, such as 35% or more, such as 40% or more, such as 45% or more, such as 50% or more and less than 100%, such as less than 90%, such as less than 80%, such as 70% or less, such as 60% or less in comparison to the conventional gypsum board without a laminate layer. Such comparison may be at any frequency and in particular at a frequency of 100 Hz or more, such as 125 Hz or more, such as 500 Hz or more, such as 1000 Hz or more, such as 2000 Hz or more, such as 2500 Hz or more, such as 3150 Hz or more, such as 4000 Hz or more. In particular, such comparison may be at 100 Hz, such as 125 Hz, such as at 500 Hz, such as at 1000 Hz, such as at 2000 Hz, such as at 2500 Hz, such as at 3150 Hz, such as at 4000 Hz. In addition, such comparison may be at any 2, such as at any 3, such as at any 4, such as at any 5 of the aforementioned frequencies.

Further, the sound transmission loss for a wall assembly including the gypsum board as disclosed herein and as conducted in accordance with ASTM E90 may result in an STC rating of 20 or more, such as 25 or more, such as 30 or more, such as 35 or more, such as 40 or more, such as 45 or more, such as 50 or more, such as 55 or more, such as 60 or more. The STC rating may be less than 70, such as 65 or less, such as 60 or less, such as 55 or less, such as 50 or less, such as 45 or less, such as 40 or less. Such comparison may be determined based on a frequency curve as identified in ASTM E90.

In addition, at a frequency of 1000 Hz, the sound transmission loss of the gypsum board as disclosed herein may be 55 dB or more, such as 56 dB or more, such as 57 dB or more, such as 58 dB or more, such as 60 dB or more. At a frequency of 2000 Hz, the sound transmission loss of the gypsum board as disclosed herein may be more than 50 dB, such as 51 dB or more, such as 52 dB or more, such as 53 dB or more, such as 55 dB or more, such as 57 dB or more. At a frequency of 4000 Hz, the sound transmission loss of the gypsum board as disclosed herein may be more than 52 dB, such as 53 dB or more, such as 55 dB or more, such as 57 dB or more, such as 59 dB or more, such as 60 dB or more.

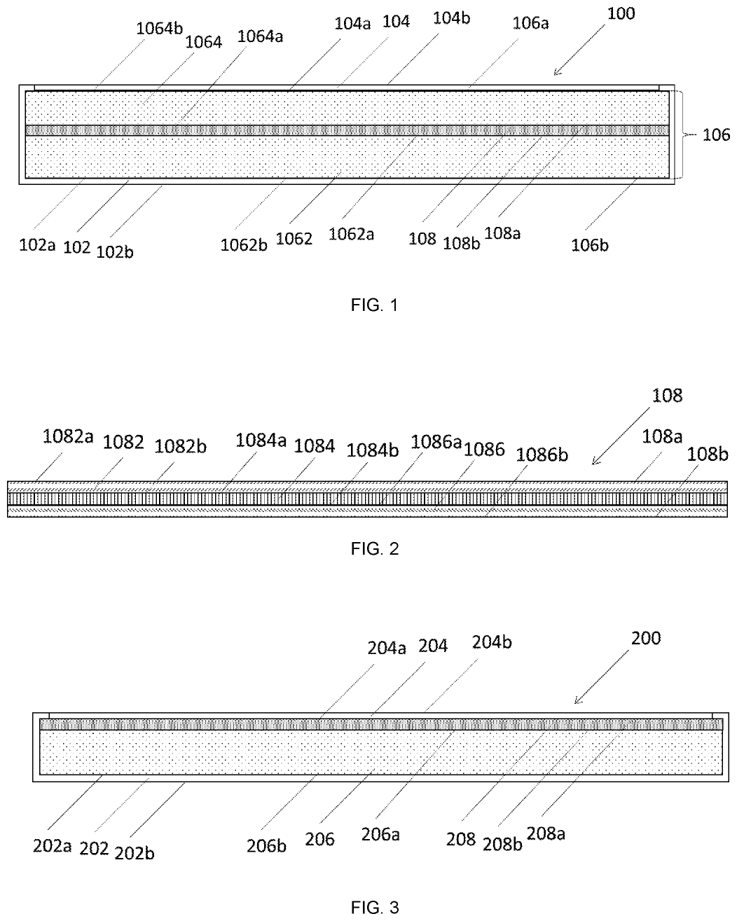

One embodiment of the present invention is further explained with respect to the illustrations presented in FIGS. 1 and 2. As illustrated in FIG. 1, the gypsum board 100 includes a gypsum core 106, a laminate layer 108 embedded within the gypsum core 106, a first facing material 102, and a second facing material 104. As illustrated, the first facing material 102 and the second facing material 104 sandwich the gypsum core 106. Also as illustrated, the gypsum core 106 may include a first gypsum core layer 1062 and a second gypsum core layer 1064.

In general, the first facing material 102 includes an outer surface 102b and an inner surface 102a. The first facing material 102 may be adjacent the first gypsum core layer 1062. In this regard, the inner surface 102a of the first facing material 102 may cover (or be adjacent, such as in direct contact with) the outer surface 1062b of the first gypsum core layer 1062. The first gypsum core layer 1062 may be adjacent the laminate layer 108. In this regard, the inner surface 1062a of the first gypsum core layer 1062 may cover (or be adjacent, such as in direct contact with) the outer surface 108b of the laminate layer 108. The laminate layer 108 may also be adjacent the second gypsum core layer 1064. In this regard, the opposing outer surface 108a of the laminate layer 108 may cover (or be adjacent, such as in direct contact with) the inner surface 1064a of the second gypsum core layer 1064. The second gypsum core layer 1064 may be adjacent the second facing material 104. In this regard, the outer surface 1064b of the second gypsum core layer 1064 may cover (or be adjacent, such as in direct contact with) the inner surface 104a of the second facing material 104, which also includes an outer surface 104b. While not intended to be limited, the first facing material 102 may be referred to as the front of the gypsum board while the second facing material 104 may be referred to as the back of the gypsum board.

While FIG. 1 illustrates the laminate layer within the gypsum core, it should be understood that the laminate layer may be used throughout the board. For instance, the laminate layer may be utilized as a facing material. In this regard, only one of the outer surfaces of the laminate layer may cover (or be adjacent, such as in direct contact with) a gypsum core layer, such as an outer surface of a gypsum core layer.

As illustrated in FIG. 2, the laminate layer 108 may include at least two outer laminate layers 1082, 1086 and an inner laminate layer 1084 sandwiched by the outer laminate layers 1082, 1086. The outer laminate layer 1082 may include an outer surface 1082a and an inner surface 1082b. The outer laminate layer 1082 may be adjacent the inner laminate layer 1084. In this regard, the inner surface 1082b of the outer laminate layer 1082 may cover (or be adjacent, such as in direct contact with) the outer surface 1084a of the inner laminate layer 1084. The inner laminate layer 1084 may also be adjacent the opposing outer laminate layer 1086. In this regard, the opposing outer surface 1084b of the inner laminate layer 1084 may cover (or be adjacent, such as in direct contact with) the inner surface 1086a of the outer laminate layer 1086, which also includes an outer surface 1086b.

As illustrated, the laminate layer includes three layers, two outer layers and one inner layer. However, it should be understood that the laminate layer may include more than 3 layers. For instance, in one embodiment, the laminate layer may include 4 layers. In another embodiment, the laminate layer may include 5 layers. In a further embodiment, the laminate layer may include even more than 5 layers.

As indicated herein, the laminate layer may include two outer laminate layers. In this regard, each outer laminate layer may be formed of the same material in one embodiment. In another embodiment, each outer laminate layer may be formed of a different material.

In general, the laminate layer may include two outer laminate layers generally having a relatively high elastic modulus. For instance, the outer laminate layers may have an elastic modulus of 0.001 GPa or more, such as 0.0015 GPa or more, such as 0.002 GPa or more, such as 0.005 GPa or more, such as 0.01 GPa or more, such as 0.05 GPa or more, such as 0.1 GPa or more, such as 0.2 GPa or more, such as 0.5 GPa or more, such as 1 GPa or more, 2 GPa or more, such as 3 GPa or more, such as 5 GPa or more, such as 10 GPa or more, such as 20 GPa or more, such as 30 GPa or more, such as 35 GPa or more, such as 40 GPa or more, such as 50 GPa or more, such as 60 GPa or more, such as 70 GPa or more, such as 80 GPa or more, such as 90 GPa or more, such as 100 GPa or more, such as 125 GPa or more, such as 150 GPa or more, such as 175 GPa or more, such as 200 GPa or more, such as 250 GPa or more, such as 300 GPa or more, such as 400 GPa or more. The elastic modulus may be 500 GPa or less, such as 400 GPa or less, such as 300 GPa or less, such as 275 GPa or less, such as 250 GPa or less, such as 225 GPa or less, such as 200 GPa or less, such as 175 GPa or less, such as 150 GPa or less, such as 125 GPa or less, such as 100 GPa or less, such as 90 GPa or less, such as 80 GPa or less, such as 70 GPa or less, such as 60 GPa or less, such as 50 GPa or less, such as 40 GPa or less, such as 30 GPa or less, such as 25 GPa or less, such as 20 GPa or less, such as 15 GPa or less, such as 10 GPa or less, such as 8 GPa or less, such as 5 GPa or less, such as 4 GPa or less, such as 3 GPa or less, such as 2 GPa or less, such as 1 GPa or less.

In one embodiment, the two outer laminate layers generally may have a higher elastic modulus than the inner laminate layer. For instance, the ratio of the elastic modulus of the inner laminate layer to the outer laminate layer may be 0.000001 or more, such as 0.00001 or more, such as 0.0001 or more, such as 0.0005 or more, such as 0.001 or more, such as 0.005 or more, such as 0.01 or more, such as 0.05 or more, such as 0.1 or more, such as 0.15 or more, such as 0.2 or more, such as 0.3 or more, such as 0.4 or more, such as 0.5 or more, such as 0.6 or more, such as 0.7 or more. The ratio of the elastic modulus of the inner laminate layer to the outer laminate layer may be less than 1, such as 0.95 or less, such as 0.9 or less, such as 0.8 or less, such as 0.7 or less, such as 0.6 or less, such as 0.5 or less, such as 0.4 or less, such as 0.3 or less, such as 0.2 or less, such as 0.1 or less, such as 0.01 or less, such as 0.001 or less. Such ratios may apply individually between a single (or at least one) outer laminate layer and the inner laminate layer. Alternatively, such ratios may apply to each of the outer laminate layers in comparison to the inner laminate layer.

In this regard, examples of materials that may be utilized for the outer laminate layer having a relatively high elastic modulus are not necessarily limited. For instance, these may include a metal or an alloy, a silicon-based glass, a carbon fiber reinforced plastic, etc. In one embodiment, the materials may include metal or an alloy thereof. For instance, the materials may include, but are not limited to, aluminum or an alloy thereof, bronze, brass, titanium or an alloy thereof, copper or an alloy thereof, iron or an alloy thereof, steel, tungsten or an alloy thereof, etc. In one particular embodiment, at least one, such as at least both, of the outer laminate layers may include metal or an alloy thereof, in particular aluminum. The outer laminate layer may also be formed of a cellulosic based material, such as a paper material.

In one embodiment, the outer laminate layer may be formed of any of the materials disclosed below regarding the inner laminate layer. For instance, these may include the polymers, such as the viscoelastic polymer, mentioned below. The polymers may also include ABS, DGEBA/PDA epoxy, BGDE/PDA epoxy, nylon 6, polycarbonate, poly(methylmethacrylate), polyethylene, poly(ethyleneoxide), poly(ethersulfone), polyisobutylene, poly(4-methyl-1-pentene), polystyrene, polysulfone, polyether based polyurethane, polybutadiene based polyurethane, polyoxymethylene, polypropylene, poly(phenylene oxide), poly(vinylchloride), poly(vinylidene fluoride), polydimethylsiloxane, polytetrafluoroethylene, as well as mixtures thereof. The utilization of such materials may be dependent on the elastic modulus and properties of such material as required by the present application.

Meanwhile, the inner laminate layer may include a material having an elastic modulus less than the outer laminate layer in one embodiment. For instance, the inner laminate layer may have an elastic modulus of 0.00001 GPA or more, such as 0.00002 GPa or more, such as 0.00005 GPa or more, such as 0.0001 GPa or more, such as 0.001 GPa or more, such as 0.01 GPa or more, such as 0.05 GPa or more, such as 0.1 GPa or more, such as 0.2 GPa or more, such as 0.3 GPa or more, such as 0.5 GPa or more, such as 1 GPa or more, such as 2 GPa or more, such as 3 GPa or more, such as 4 GPa or more, such as 5 GPa or more, such as 7 GPa or more, such as 10 GPa or more, such as 15 GPa or more, such as 20 GPa or more, such as 25 GPa or more. The elastic modulus may be 30 GPa or less, such as 25 GPa or less, such as 20 GPa or less, such as 15 GPa or less, such as 10 GPa or less, such as 8 GPa or less, such as 6 GPa or less, such as 5 GPa or less, such as 4 GPa or less, such as 3 GPa or less, such as 2 GPa or less, such as 1 GPa or less, such as 0.5 GPa or less, such as 0.4 GPa or less, such as 0.3 GPa or less, such as 0.2 GPa or less, such as 0.1 GPa or less.

In one embodiment, the inner laminate layer may be made from a polymer. For instance, the polymer may comprise a thermoplastic polymer or a thermoset polymer. In one embodiment, the inner laminate layer comprises a thermoplastic polymer. In another embodiment, the inner laminate layer comprises a thermoset polymer. In one particular embodiment, the inner laminate layer comprises a combination of a thermoplastic polymer and a thermoset polymer. In a further embodiment, the inner laminate layer may be an elastomer, in particular a thermoplastic elastomer.

Suitable polymers include, as non-limiting examples, synthetic resins, polymers and copolymers, and latex polymers as are known in the art. In one embodiment, the polymer is an acrylic (or acrylate) polymer or copolymer. One such non-limiting example is Acronal®, an acrylate copolymer commercially available from BASF (Charlotte, N.C.). Another non-limiting example is QuietGlue™, which includes an acrylic (or acrylate) polymer and in particular two of such polymers. The formulation for QuietGlue™ can be found in U.S. Pat. No. 7,921,965, which is incorporated herein by reference in its entirety. When provided in a formulation, the concentration of the acrylic (acrylate) polymer may not necessarily be limited. However, such formulation should have sufficient fluidity (e.g., with the presence of water) to allow for the formulation and polymer to be handled and processed for forming the inner laminate layer.

Other examples of polymers that may be utilized include ABS, DGEBA/PDA epoxy, BGDE/PDA epoxy, nylon 6, polycarbonate, poly(methylmethacrylate), polyethylene, poly(ethyleneoxide), poly(ethersulfone), polyisobutylene, poly(4-methyl-1-pentene), polystyrene, polysulfone, polyether based polyurethane, polybutadiene based polyurethane, polyoxymethylene, polypropylene, poly(phenylene oxide), poly(vinylchloride), poly(vinylidene fluoride), polydimethylsiloxane, polytetrafluoroethylene, as well as mixtures thereof.

In one embodiment, the polymer may be a rubber. The rubber is not necessarily limited. For instance, the rubber may be a natural rubber, a nitrile rubber (e.g., a nitrile butadiene rubber), an ethylene propylene diene monomer rubber, a neoprene rubber, a silicone rubber (e.g., a polysiloxane), a styrene butadiene rubber, a butyl rubber (e.g., isobutylene isoprene), a polyurethane rubber, a fluoroelastomer, a fluorosilicone rubber, or a combination thereof.

In one embodiment, the polymer may be a viscoelastic polymer. For instance, the polymer may be provided as a glue, such as a viscoelastic glue. Such glue may be provided on an outer laminate layer in order to form the inner laminate layer.

In addition, the polymer may have a relatively low glass transition temperature. For instance, the polymer may have a glass transition temperature of room temperature or less. For instance, the polymer may have a glass transition temperature of 200° C. or less, such as 180° C. or less, such as 150° C. or less, such as 130° C. or less, such as 100° C. or less, such as 80° C. or less, such as 60° C. or less, such as 50° C. or less, such as 40° C. or less, such as 30° C. or less, such as 25° C. or less, such as 20° C. or less, such as 10° C. or less, such as 5° C. or less, such as 1° C. or less, such as 0° C. or less, such as −5° C. or less, such as −10° C. or less, such as −15° C. or less, such as −20° C. or less, such as −25° C. or less, such as −30° C. or less, such as −35° C. or less, such as −40° C. or less, such as −50° C. or less. The polymer may have a glass transition temperature of −90° C. or more, such as −80° C. or more, such as −75° C. or more, such as −70° C. or more, such as −65° C. or more, such as −60° C. or more, such as −55° C. or more, such as −50° C. or more, such as −40° C. or more, such as −30° C. or more, such as −20° C. or more, such as −10° C. or more, such as 0° C. or more, such as 10° C. or more, such as 20° C. or more, such as 30° C. or more, such as 50° C. or more, such as 80° C. or more, such as 100° C. or more.

The polymer may have a certain longitudinal shear absorption coefficient (aL) as determined at 25° C. and 2 MHz. For instance, the longitudinal shear absorption coefficient may be 0.1 dB/cm or more, such as 0.3 dB/cm or more, such as 0.5 dB/cm or more, such as 1 dB/cm or more, such as 1.3 dB/cm or more, such as 1.5 dB/cm or more, such as 2 dB/cm or more, such as 3 dB/cm or more, such as 5 dB/cm or more, such as 6 dB/cm or more, such as 8 dB/cm or more, such as 10 dB/cm or more, such as 15 dB/cm or more, such as 20 dB/cm or more, such as 30 dB/cm or more, such as 50 dB/cm or more. The longitudinal shear absorption coefficient may be 100 dB/cm or less, such as 70 dB/cm or less, such as 50 dB/cm or less, such as 30 dB/cm or less, such as 25 dB/cm or less, such as 20 dB/cm or less, such as 10 dB/cm or less, such as 9 dB/cm or less, such as 8 dB/cm or less, such as 7 dB/cm or less, such as 6 dB/cm or less, such as 5 dB/cm or less, such as 4 dB/cm or less, such as 3 dB/cm or less, such as 2 dB/cm or less.

The polymer may have a certain longitudinal shear velocity (CO as determined at 25° C. and 2 MHz. For instance, the longitudinal shear velocity may be 500 m/s or more, such as 800 m/s or more, such as 1,000 m/s or more, such as 1,300 m/s or more, such as 1,500 m/s or more, such as 1,800 m/s or more, such as 2,000 m/s or more, such as 2,100 m/s or more, such as 2,200 m/s or more, such as 2,300 m/s or more, such as 2,400 m/s or more, such as 2,500 m/s or more, such as 2,600 m/s or more, such as 2,800 m/s or more. The longitudinal shear velocity may be 5,000 m/s or less, such as 4,000 m/s or less, such as 3,500 m/s or less, such as 3,000 m/s or less, such as 2,900 m/s or less, such as 2,800 m/s or less, such as 2,700 m/s or less, such as 2,600 m/s or less, such as 2,500 m/s or less, such as 2,400 m/s or less, such as 2,300 m/s or less, such as 2,200 m/s or less, such as 2,100 m/s or less, such as 2,000 m/s or less, such as 1,900 m/s or less, such as 1,700 m/s or less, such as 1,500 m/s or less, such as 1,300 m/s or less, such as 1,200 m/s or less.

In one embodiment, the inner laminate layer may be a foam type layer. The foam may be an open-cell foam in one embodiment. In another embodiment, the foam may be a closed-cell foam. In a further embodiment, the foam layer may include a combination of open-cells and closed-cells.

In one embodiment, the foam may have an open pore geometry or constitute an open-celled foam. In general, such foams generally contain interconnected cells, which allow for the passage of gas or a fluid through the void space from one cell to the next. This is contrary to closed-cell foams, which may not have interconnected cell openings. In some embodiments, at least 0.01% to about 100% of the one or more pores contain an open pore geometry. In some embodiments, at least 10% to about 90% of the one or more pores contain an open pore geometry. In some embodiments, at least about 20% to about 80% of the one or more pores contain an open pore geometry. Accordingly, in certain embodiments, at least 0.01%, such as at least 1%, such as at least 10%, such as at least 20%, such as at least 30%, such as at least 40%, such as at least 50%, such as at least 60%, such as at least 70%, such as at least 80%, such as at least 90% of the one or more pores contain an open pore geometry. In addition, in certain embodiments, 100% or less, such as 95% or less, such as 90% or less, such as 85% or less, such as 80% or less, such as 75% or less of the one or more pores contain an open pore geometry. In some embodiments, at least 50% to up to 95% or less of the pores contain an open pore geometry. In some embodiments, at least 50% to up to 85% or less of the pores contain an open pore geometry. In some embodiments, at least 50% to up to 75% or less of the pores contain an open pore geometry.

In one embodiment, the foam may have a closed pore geometry or constitute a closed-celled foam. In general, closed cell foams are those in which the cells are enclosed and typically are tightly pressed together. Generally, closed cell foams may have a higher density and greater pressure resistance. In some embodiments, at least 1% to about 100% of the one or more pores may contain a closed pore geometry. In some embodiments, at least 10% to about 90% of the one or more pores may contain a closed pore geometry, such as at least 20%, such as at least 30%, such as at least 40%, such as at least 50%, such as at least 60%.

Further, in one embodiment, the inner laminate layer may be a fibrous mat or a felt material. Such layer may be synthetic such that it is formed from synthetic materials, such as synthetic fibrous materials. Alternatively, such lay may be natural such that it is formed from natural materials, such as natural fibrous materials. In another embodiment, such layer may be formed from a combination of synthetic materials and natural materials.

In addition, in one embodiment, any of the aforementioned layers may be continuous. In another embodiment, any of the aforementioned layers may be discontinuous. In particular, the polymers as disclosed herein, such as the viscoelastic polymer and corresponding viscoelastic glue, may be provided in a discontinuous manner. For instance, they may be provided as a pattern. Alternatively, they may be provided in a random configuration. Without intending to be limited, such discontinuity may allow for improvement in sound dampening properties.

Another embodiment of the present invention is further explained with respect to the illustration presented in FIG. 3. As illustrated in FIG. 3, the gypsum board 200 includes a gypsum core layer 206, a laminate layer 208 on the gypsum core layer 206, a first facing material 202, and a second facing material 204. As illustrated, the first facing material 202 and the second facing material 204 sandwich the gypsum core layer 206 and the laminate layer 208.

In general, the first facing material 202 includes an outer surface 202b and an inner surface 202a. The first facing material 202 may be adjacent the first gypsum core layer 206b. In this regard, the inner surface 202a of the first facing material 202 may cover (or be adjacent, such as in direct contact with) the outer surface 206b of the first gypsum core layer 206. The first gypsum core layer 206 may be adjacent the laminate layer 208. In this regard, the inner surface 206a of the first gypsum core layer 206 may cover (or be adjacent, such as in direct contact with) the inner surface 208b of the laminate layer 208. The laminate layer 208 may also be adjacent the second facing material 204. In this regard, the outer surface 208a of the laminate layer 208 may cover (or be adjacent, such as in direct contact with) the inner surface 204a of the second facing material 204, which also includes an outer surface 204b. While not intended to be limited, the first facing material 202 may be referred to as the front of the gypsum board while the second facing material 204 may be referred to as the back of the gypsum board. The laminate layer 208 may be the same configuration as described herein with respect to laminate layer 108 in FIGS. 1 and 2.

With a gypsum board as presented in FIG. 3, it may be utilized as a standalone gypsum board in one embodiment. In another embodiment, it may be utilized in a retrofit application that is adhered or disposed on an existing and possibly installed gypsum board.

As indicated herein, the laminate layer includes two outer laminate layers and an inner laminate layer. The laminate layer may have a thickness of 0.001 inches or more, such as 0.002 inches or more, such as 0.003 inches or more, such as 0.005 inches or more, such as 0.01 inches or more, such as 0.03 inches or more, such as 0.05 inches or more, such as 0.08 inches or more, such as 0.1 inches or more, such as 0.15 inches or more. The thickness may be 0.5 inches or less, such as 0.4 inches or less, such as 0.3 inches or less, such as 0.25 inches or less, such as 0.2 inches or less, such as 0.15 inches or less, such as 0.1 inches or less, such as 0.08 inches or less, such as 0.05 inches or less, such as 0.04 inches or less, such as 0.03 inches or less, such as 0.02 inches or less, such as 0.01 or less.

Meanwhile, the outer laminate layer may have a thickness of 0.001 inches or more, such as 0.002 inches or more, such as 0.003 inches or more, such as 0.005 inches or more, such as 0.01 inches or more, such as 0.03 inches or more, such as 0.05 inches or more, such as 0.08 inches or more, such as 0.1 inches or more, such as 0.15 inches or more. The thickness may be 0.3 inches or less, such as 0.25 inches or less, such as 0.2 inches or less, such as 0.15 inches or less, such as 0.1 inches or less, such as 0.08 inches or less, such as 0.05 inches or less, such as 0.04 inches or less, such as 0.03 inches or less, such as 0.02 inches or less, such as 0.01 or less.

The inner laminate layer may have a thickness of 0.001 inches or more, such as 0.002 inches or more, such as 0.003 inches or more, such as 0.005 inches or more, such as 0.01 inches or more, such as 0.03 inches or more, such as 0.05 inches or more, such as 0.08 inches or more, such as 0.1 inches or more, such as 0.15 inches or more. The thickness may be 0.3 inches or less, such as 0.25 inches or less, such as 0.2 inches or less, such as 0.15 inches or less, such as 0.1 inches or less, such as 0.08 inches or less, such as 0.05 inches or less, such as 0.04 inches or less, such as 0.03 inches or less, such as 0.02 inches or less, such as 0.01 or less.

As indicated herein, the laminate layer may include three layers or even more than three layers, such as five layers. In such instance, when the laminate layer includes five layers, the innermost central layer may be of the material and have the properties of the inner laminate layer as disclosed herein. Meanwhile, the outermost layers may be of the material and have the properties of the outer laminate layer as disclosed herein. In addition, the intermediate layers may also be of the material and have the properties of the outer laminate layer as disclosed herein. Accordingly, any properties or ratios regarding the outer laminate layer and the inner laminate layer may also apply to the intermediate laminate layer and the inner laminate layer.

However, in one embodiment, the aforementioned layers may be reordered as needed and are not limited by the scope of the invention. For instance, the outermost layers may be in the position of the innermost layer as defined herein and the innermost layer may be in the position of the outermost layers as defined herein. In particular, the materials and properties of the outermost layers would apply to the innermost layer. In addition, the materials and properties of the innermost layer would apply to the outermost layers. In this regard, such an orientation of layers may be interchangeable thereby allowing for manipulation of the laminate layer and the resulting properties and characteristics of the gypsum board.

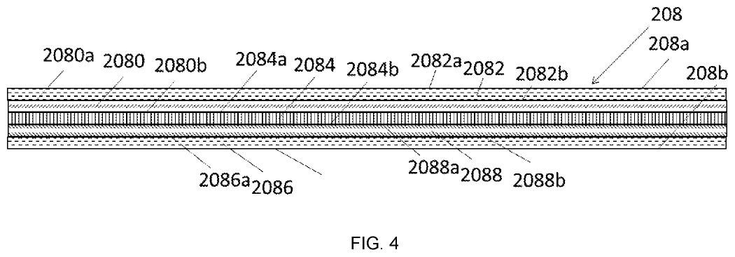

As illustrated in FIG. 4, the laminate layer 208 may include at least two outer laminate layers 2082, 2086 and an inner laminate layer 2084 sandwiched by the outer laminate layers 2082, 2086 and two intermediate laminate layers 2080, 2088. The outer laminate layer 2082 may include an outer surface 2082a and an inner surface 2082b. The outer laminate layer 2082 may be adjacent the intermediate laminate layer 2080. In this regard, the inner surface 2082b of the outer laminate layer 2082 may cover (or be adjacent, such as in direct contact with) the outer surface 2080a of the intermediate laminate layer 2080. The intermediate laminate layer 2080 may be adjacent the inner laminate layer 2084. In this regard, the inner surface 2080b of the intermediate laminate layer 2080 may cover (or be adjacent, such as in direct contact with) the outer surface 2084a of the inner laminate layer 2084. The inner laminate layer 2084 may also be adjacent the opposing intermediate laminate layer 2088. In this regard, the opposing outer surface 2084b of the inner laminate layer 2084 may cover (or be adjacent, such as in direct contact with) the inner surface 2088a of the intermediate laminate layer 2088. The intermediate laminate layer 2088 may be adjacent the opposing outer laminate layer 2086. In this regard, the outer surface 2088b of the intermediate laminate layer 2088 may cover (or be adjacent, such as in direct contact with) the inner surface 2086a of the outer laminate layer 2086, which also includes an outer surface 2086b. Furthermore, the opposing outer surfaces 108a, 108b of the laminate layer 208 may cover (or be adjacent, such as in direct contact with) the inner surface of a gypsum core layer. However, as indicated herein, the laminate layer may be a facing material and thus only one of the outer surfaces of the laminate layer may cover (or be adjacent, such as in direct contact with) a gypsum core layer, such as an outer surface of a gypsum core layer.

In one particular embodiment, the laminate layer may include five layers. In this regard, the outer laminate layers may be formed of a cellulosic based material, such as a paper material. The inner laminate layer may be formed from a polymer, such as a viscoelastic polymer. In addition, the intermediate laminate layers may be formed from a metal or an alloy thereof, such as aluminum or an alloy thereof.

In addition, the gypsum board may include one laminate layer as disclosed herein or multiple laminate layers. For instance, the gypsum board may include the laminate layer at various depths or positions within the gypsum core and/or various faces of the gypsum core. For instance, the gypsum board may include two laminate layers as disclosed herein wherein the laminate layers are provided within the gypsum core. In another embodiment, the gypsum board may include two laminate layers wherein one laminate layer is provided within the gypsum core and another laminate layer is provided on a face of the gypsum core. In a further embodiment, the gypsum board may include two laminate layers wherein both laminate layers are provided on a face of the gypsum core. In another embodiment, the gypsum board may include three laminate layers. For instance, one laminate layer may be provided within the gypsum core while the other two laminate layers may be provided on a face of the gypsum core. Alternatively, two laminate layers may be provided within the gypsum core while one laminate layer may be provided on a face of the gypsum core.

In general, the present invention is also directed to a method of making a gypsum board. As indicated herein, the gypsum board includes a gypsum core including a first gypsum core layer and a second gypsum core layer. Each gypsum core layer includes calcium sulfate dihydrate and may include various additives as described herein and generally known in the art. In this regard, the gypsum core, in particular each gypsum core layer, is formed from a gypsum slurry. In general, the gypsum slurry includes at least stucco and water. In this regard, the method may also include a step of combining stucco, water, and any optional additives as mentioned herein.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the hemihydrate used to form the panel is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be α-hemihydrate, β-hemihydrate, or a mixture thereof.

In addition to the stucco, the gypsum slurry may also contain other hydraulic materials. These hydraulic materials may include calcium sulfate anhydrite, land plaster, cement, fly ash, or any combinations thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the hydraulic material.

As indicated above, the gypsum slurry may also include water. Water may be employed for fluidity and also for rehydration of the calcined gypsum to allow for setting. The amount of water utilized is not necessarily limited by the present invention.

The weight ratio of the water to the stucco may be 0.1 or more, such as 0.2 or more, such as 0.2 or more, such as 0.3 or more, such as 0.4 or more, such as 0.5 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In general, the composition of the gypsum core, in particular each gypsum core layer, is not necessarily limited and may include any additives as known in the art. For instance, the additives may include dispersants, foam or foaming agents including aqueous foam (e.g. sulfates), set accelerators (e.g., BMA, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants, fillers (e.g., glass fibers), waxes, acids (e.g., boric acid), secondary phosphates (e.g., condensed phosphates or orthophosphates including trimetaphosphates, polyphosphates, and/or cyclophosphates, etc.), mixtures thereof, natural and synthetic polymers, starches, etc. In general, it should be understood that the types and amounts of such additives are not necessarily limited by the present invention.

In general, each additive may be present in the gypsum core, in particular each gypsum core layer, in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less. The aforementioned weight percentages may also apply based on the weight of the gypsum in the gypsum board. In one embodiment, the aforementioned weight percentages may also apply based on the weight of the gypsum board.

Alternatively, the weight percentage may be based on the weight of the gypsum core. In a further embodiment, such weight percentage may be based on the weight of a respective gypsum core layer within the gypsum core. Also, the aforementioned weight percentages may also apply based on the solids content of the gypsum slurry.

The manner in which the components are combined for forming the gypsum slurry is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer.

Accordingly, the method may include providing a first facing material wherein the first facing material has an outer surface and an opposing inner surface. The first facing material may be conveyed on a conveyor system (i.e., a continuous system for continuous manufacture of gypsum board). Then, the method may include a step of depositing a first gypsum slurry onto the first facing material, in particular the inner surface of the first facing material.

Next, a laminate layer may be deposited onto the first gypsum slurry. In this regard, the laminate layer may be deposited onto the first gypsum slurry as a laminate. For instance, a laminate including the first laminate layer, the second laminate layer, and the third laminate layer (or additional laminate layers as disclosed herein) may be deposited onto the first gypsum slurry. Alternatively, the layers of the laminate layer may be deposited individually or in various combinations. For instance, a first laminate layer may be deposited followed by a second laminate layer and followed by a third laminate layer (also followed by any subsequent laminate layers as disclosed herein). Alternatively, the second laminate layer may be provided with either the first or third laminate layer. For instance, in one embodiment, the first and second laminate layers may together be provided onto the first gypsum slurry followed by the third laminate layer. Alternatively, the first laminate layer may be provided onto the first gypsum slurry followed by the second and third laminate layers together. Regardless of the number of individual layers within the laminate layer, it should be understood that any combination of individual layers may be combined and provided onto the gypsum slurry or respective layer for forming the laminate layer.

The aforementioned mentions a laminate layer including three individual laminate layers. In this regard, the first and third laminate layers may comprise the outer laminate layers while the second laminate layer may comprise the inner laminate layer. However, it should be understood that the laminate layer may include more than layers as indicated herein. For instance, the laminate may include 4 individual layers, 5 individual layers, or even more.

After providing the laminate layer, a second gypsum slurry may be deposited onto the laminate layer. Then, a second facing material may be provided onto the second gypsum slurry. In this regard, laminate layer is sandwiched between the first and second gypsum slurries and the first and second gypsum slurries are sandwiched between the facing materials in order to form the gypsum board. Such deposition of gypsum slurries may provide a gypsum board having layers as illustrated in FIG. 1.

Upon deposition of the gypsum slurries, the calcium sulfate hemihydrate reacts with the water to convert the calcium sulfate hemihydrate into a matrix of calcium sulfate dihydrate. Such reaction may allow for the gypsum to set and become firm thereby allowing for the boards to be cut at the desired length. In this regard, the method may comprise a step of reacting calcium sulfate hemihydrate with water to form calcium sulfate dihydrate or allowing the calcium sulfate hemihydrate to convert to calcium sulfate dihydrate. In this regard, the method may allow for the slurry to set to form a gypsum board. In addition, during this process, the method may allow for dewatering of the gypsum slurry, in particular dewatering any free water instead of combined water of the gypsum slurry. Such dewatering may occur prior to the removal of any free moisture or water in a heating device after a cutting step. Thereafter, the method may also comprise a step of cutting a continuous gypsum sheet into a gypsum board. Then, after the cutting step, the method may comprise a step of supplying the gypsum board to a heating or drying device. For instance, such a heating or drying device may be a kiln and may allow for removal of any free water. The temperature and time required for drying in such heating device are not necessarily limited by the present invention.

In one embodiment, the gypsum board as disclosed herein may be sandwiched or laminated with another gypsum board. Such another gypsum board may be a second gypsum board as disclosed herein or may alternatively be another type of gypsum board. The first gypsum board and the second gypsum board may be sandwiched using an adhesive. For instance, the adhesive may be a polymer or a glue. In particular, the adhesive may be a viscoelastic polymer and/or viscoelastic glue as disclosed herein.

As indicated herein, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

As indicated herein, the gypsum core includes a first gypsum core layer and a second gypsum core layer. In one embodiment, the first gypsum core layer may have a thickness that is approximately the same as the thickness of the second gypsum core layer. For instance, the ratio of the thickness of the first gypsum core layer to the second gypsum core layer may be 0.8 or more, such as 0.9 or more, such as 0.95 or more, such as 0.98 or more, such as 0.99 or more to 1.2 or less, such as 1.1 or less, such as 1.05 or less, such as 1.02 or less, such as 1.01 or less. For instance, the ratio may be about 1. In general, general, thickness refers to the direction that is orthogonal (and in a different plane) to the machine or conveying direction of the first facing material, gypsum core, and second facing material.

In another embodiment, the first gypsum core layer may have a thickness that is different from the thickness of the second gypsum core layer. For instance, the first gypsum core layer may have a thickness less than the thickness of the second gypsum core layer. In this regard, the ratio of the thickness of the first gypsum core layer to the second gypsum core layer may be 0.0001 or more, such as 0.001 or more, such as 0.01 or more, such as 0.05 or more, such as 0.1 or more, such as 0.2 or more, such as 0.3 or more, such as 0.4 or more, such as 0.5 or more, such as 0.6 or more, such as 0.7 or more. The ratio of the thickness of the first gypsum core layer to the second gypsum core layer may be less than 0.9, such as 0.8 or less, such as 0.7 or less, such as 0.6 or less, such as 0.5 or less, such as 0.4 or less, such as 0.3 or less, such as 0.2 or less.

Alternatively, the second gypsum core layer may have a thickness less than the thickness of the first gypsum core layer. In this regard, the ratio of the thickness of the second gypsum core layer to the first gypsum core layer may be 0.0001 or more, such as 0.001 or more, such as 0.01 or more, such as 0.05 or more, such as 0.1 or more, such as 0.2 or more, such as 0.3 or more, such as 0.4 or more, such as 0.5 or more, such as 0.6 or more, such as 0.7 or more. The ratio of the thickness of the second gypsum core layer to the first gypsum core layer may be less than 0.9, such as 0.8 or less, such as 0.7 or less, such as 0.6 or less, such as 0.5 or less, such as 0.4 or less, such as 0.3 or less, such as 0.2 or less.

In one embodiment, the gypsum core may also include a third gypsum core layer. The third gypsum core layer may be provided between the first gypsum core layer and the first facing material. The third gypsum core layer may have a density that is greater than the first gypsum core layer, the second gypsum core layer, or both. Accordingly, the third gypsum core layer may be formed without the use of a foaming agent or with a reduced amount of foaming agent, which may be utilized in forming the first and/or second gypsum core layers. In this regard, in one embodiment, the third gypsum core layer may have the same composition as the first and/or second gypsum core layers except that they may be formed using a foaming agent.

The third gypsum core layer may have a thickness that is 0.5% or more, such as 1% or more, such as 2% or more, such as 3% or more, such as 4% or more, such as 5% or more, such as 10% or more, such as 15% or more the thickness of the first (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the first (or foamed) gypsum core layer. In one embodiment, such relationship may also be between the third gypsum core layer and the second gypsum core layer.

The density of the first (or foamed) gypsum core layer may be 0.5% or more, such as 1% or more, such as 2% or more, such as 3% or more, such as 4% or more, such as 5% or more, such as 10% or more, such as 15% or more the density of the third (or non-foamed) gypsum core layer. The density of the first (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the third (or non-foamed) gypsum core layer. In one embodiment, such relationship may also be between the third gypsum core layer and the second gypsum core layer. In addition, in one embodiment, all of the gypsum layers may have a different density.

In general, when a third gypsum core slurry is provided, the method may include the following: providing a first facing material, depositing a third gypsum slurry onto the first facing material, depositing a first gypsum slurry onto the third gypsum layer, providing a laminate layer onto the first gypsum slurry, depositing a second gypsum slurry onto the laminate layer, providing a second facing material onto the second gypsum slurry, and allowing the calcium sulfate hemihydrate to react with the water to convert the calcium sulfate hemihydrate into a matrix of calcium sulfate dihydrate. The method may also include other steps as mentioned above.

In one embodiment, the gypsum core may also include a fourth gypsum core layer. The fourth gypsum core layer may be provided between the second gypsum core layer and the second facing material. The fourth gypsum core layer may have a density that is greater than the first gypsum core layer, the second gypsum core layer, or both. Accordingly, the fourth gypsum core layer may be formed without the use of a foaming agent or with a reduced amount of foaming agent, which may be utilized in forming the first and/or second gypsum core layers. In this regard, in one embodiment, the fourth gypsum core layer may have the same composition as the first and/or second gypsum core layers except that they may be formed using a foaming agent. In one embodiment, the fourth gypsum core layer may have the same composition as the third gypsum core layer.

The fourth gypsum core layer may have a thickness that is 0.5% or more, such as 1% or more, such as 2% or more, such as 3% or more, such as 4% or more, such as 5% or more, such as 10% or more, such as 15% or more the thickness of the first (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the first (or foamed) gypsum core layer. In one embodiment, such relationship may also be between the fourth gypsum core layer and the second gypsum core layer. Furthermore, the thickness of the fourth gypsum core layer may be the same as the thickness of the third gypsum core layer.

The density of the first (or foamed) gypsum core layer may be 0.5% or more, such as 1% or more, such as 2% or more, such as 3% or more, such as 4% or more, such as 5% or more, such as 10% or more, such as 15% or more the density of the fourth (or non-foamed) gypsum core layer. The density of the first (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the fourth (or non-foamed) gypsum core layer. In one embodiment, such relationship may also be between the fourth gypsum core layer and the second gypsum core layer. In addition, in one embodiment, all of the gypsum layers may have a different density. Furthermore, the density of the fourth gypsum core layer may be the same as the density of the third gypsum core layer.

In general, when a fourth gypsum core slurry is provided, the method may include the following: providing a first facing material, optionally depositing a third gypsum slurry onto the first facing material, depositing a first gypsum slurry onto the third gypsum layer, providing a laminate layer onto the first gypsum slurry, depositing a second gypsum slurry onto the laminate layer, depositing a fourth gypsum slurry onto the second gypsum slurry, providing a second facing material onto the fourth gypsum slurry, and allowing the calcium sulfate hemihydrate to react with the water to convert the calcium sulfate hemihydrate into a matrix of calcium sulfate dihydrate. The method may also include other steps as mentioned above.

In another embodiment, the gypsum board may be made as mentioned above without the application of a second gypsum layer. For instance, such method may allow for the production of a gypsum board as illustrated in FIG. 3.

In a further embodiment, the gypsum board may be made via offline production. For instance, a first gypsum core layer having a first facing material may be provided. Thereafter, a laminate layer as defined herein may be provided on the first gypsum core layer. Next, if desired, a second gypsum core layer having a second facing material may be provided onto the laminate layer. If a second gypsum core layer is not desired, then the laminate layer may be provided with a second facing material or a second facing material may be provided onto the laminate layer. Using such a method, the layers and materials may be connected using means known in the art. For instance, in one embodiment, an adhesive may be utilized to combine the respective layers and/or materials. In another embodiment, an end tape and/or edge tape may be utilized to provide the layers and/or materials within the gypsum board. Such tape may wrap around from one major planar surface to the other major planar surface and assist with securing the layers and materials in position within the gypsum board.

In addition, in certain embodiments, when a facing material may be present on the gypsum board, at least some, and in some embodiments all, of the facing material may be removed from one face of the gypsum core. Thereafter, a laminate layer may be provided thereon. In certain embodiments, another gypsum board with a gypsum core may be provided adjacent the laminate layer. Such gypsum board may have also had at least some, and in some embodiments all, of the facing material removed from one face of the gypsum core. In this regard, the laminate layer may be formed such that it is disposed on the gypsum core and at least some of the facing material. The facing material may be removed using techniques known in the art, such as sanding.

The gypsum board disclosed herein may have many applications. For instance, the gypsum board may be used as a standalone board in construction for the preparation of walls, ceilings, floors, etc. In addition, the gypsum board may be installed on an existing or installed gypsum board, wall, or panel. As used in the present disclosure, the term “gypsum board,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum board forms part of a building structure, such as a wall or ceiling. The installation of the gypsum board as disclosed herein can provide a desired acoustical performance to an existing or installed gypsum board that does not have any sound damping capabilities or ineffective sound damping abilities or can be used to further enhance acoustical performance.

Regardless of the application, the gypsum board as disclosed herein provides the desired sound damping properties. In particular, the gypsum board may exhibit a decay time of 2 seconds or less, such as 1.8 seconds or less, such as 1.5 seconds or less, such as 1.3 seconds or less, such as 1 second or less, such as 0.9 seconds or less, such as 0.8 seconds or less, such as 0.7 seconds or less, such as 0.6 seconds or less, such as 0.5 seconds or less, such as 0.4 seconds or less, such as 0.3 seconds or less, such as 0.2 seconds or less, such as 0.1 seconds or less, such as 0.01 seconds or less, such as 0.001 seconds or less. The decay time may be 0.0001 seconds or more, such as 0.001 seconds or more, such as 0.01 seconds or more, such as 0.01 seconds or more, such as 0.1 seconds or more, such as 0.2 seconds or more, such as 0.3 seconds or more, such as 0.4 seconds or more, such as 0.5 seconds or more, such as 0.6 seconds or more, such as 0.7 seconds or more. In general, the lower the decay time, the better the performance of the gypsum board and sound damping properties. In one embodiment, the decay time may be reduced by at least 10%, such as at least 20%, such as at least 30%, such as at least 40%, such as at least 50%, such as at least 60%, such as at least 70%, such as at least 80%, such as at least 90%, such as at least 95% in comparison to a control board. For example, such control board may be the same board as the inventive gypsum board except without the use of the laminate layer.

The thickness of the gypsum board, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum boards may be combined to create another gypsum board. For example, at least two gypsum boards having a thickness of about 5/16 inches each may be combined or sandwiched to create a gypsum board having a thickness of about ⅝ inches. While this is one example, it should be understood that any combination of gypsum boards may be utilized to prepare a sandwiched gypsum board. With regard to the thickness, the term “about” may be defined as within 10%, such as within 5%, such as within 4%, such as within 3%, such as within 2%, such as within 1%.

The thickness of each gypsum core layer is also not necessarily limited and may be from about 1/10 inches to about 1 inch. For instance, the thickness may be at least I/O inches, such as at least ⅕ inches, such as at least ¼ inches, such as at least 3/10 inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. In addition, at least two gypsum core layers may be combined to create another gypsum board. With regard to the thickness, the term “about” may be defined as within 10%, such as within 5%, such as within 4%, such as within 3%, such as within 2%, such as within 1%.

In addition, the board weight of the gypsum board is not necessarily limited. For instance, the gypsum board may have a board weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The board weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such board weight may be a dry board weight such as after the board leaves the heating or drying device (e.g., kiln).

In addition, the gypsum board may have a density of about 5 pcf or more, such as about 10 pcf or more, such as about 15 pcf or more, such as about 20 pcf or more. The board may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less.

In addition, the density of each gypsum core layer may be adjusted in order to optimize the performance of the gypsum board. In one embodiment, the first gypsum core layer and the second gypsum core layer may have the same density. In another embodiment, the first gypsum core layer and the second gypsum core layer may have a different density. The density of the first gypsum core layer may be about 5 pcf or more, such as about 10 pcf or more, such as about 15 pcf or more, such as about 20 pcf or more. The density of the first gypsum core layer about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less. The density of the second gypsum core layer may be about 5 pcf or more, such as about 10 pcf or more, such as about 15 pcf or more, such as about 20 pcf or more. The density of the second gypsum core layer about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less. The density of one gypsum core layer may be within 5%, such as within 10%, such as within 20%, such as within 30%, such as within 40%, such as within 50%, such as within 80%, such as within 100%, such as within 200%, such as within 300%, such as within 500% of the density of another gypsum core layer.

The gypsum board may have a certain nail pull resistance, which generally is a measure of the force required to pull a gypsum panel off of a wall by forcing a fastening nail through the panel. The values obtained from the nail pull test generally indicate the maximum stress achieved while the fastener head penetrates through the board surface and core. In this regard, the gypsum board exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396. The nail pull resistance may be about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396. Such nail pull resistance may be based upon the thickness of the gypsum board. For instance, when conducting a test, such nail pull resistance values may vary depending on the thickness of the gypsum board. As an example, the nail pull resistance values above may be for a ⅝ inch board. However, it should be understood that instead of a ⅝ inch board, such nail pull resistance values may be for any other thickness gypsum board as mentioned herein.

The gypsum board may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum board. For instance, when conducting a test, such compressive strength values may vary depending on the thickness of the gypsum board. As an example, the compressive strength values above may be for a ⅝ inch board. However, it should be understood that instead of a ⅝ inch board, such compressive strength values may be for any other thickness gypsum board as mentioned herein.

In addition, the gypsum board may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396. The gypsum board may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396. In addition, the gypsum board may have an end hardness according to the aforementioned values. Further, the gypsum board may have an edge hardness according to the aforementioned values. Such core hardness may be based upon the thickness of the gypsum board. For instance, when conducting a test, such core hardness values may vary depending on the thickness of the gypsum board. As an example, the core hardness values above may be for a ⅝ inch board. However, it should be understood that instead of a ⅝ inch board, such core hardness values may be for any other thickness gypsum board as mentioned herein.

In addition, it may also be desired to have an effective bond between the facing material and the gypsum core. Typically, a humidified bond analysis is performed for 2 hours in a humidity chamber at 90° F. and 90% humidity. In this test, after exposure, the facing material is removed to determine how much remains on the gypsum board. The percent coverage can be determined using various optical analytical techniques. In this regard, the facing material may cover less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum board. Alternatively, such percentage may be for a back of the gypsum board. Further, such percentages may apply to the face and the back of the gypsum board. In addition, such values may be for an average of at least 3 gypsum boards, such as at least 5 gypsum boards.

In addition, the gypsum board may have certain impact resistant properties as determined in accordance with ASTM C1629/C1629M (2011). For instance, in accordance with a soft body impact test, the impact resistance may be 100 J or more, such as 125 J or more, such as 150 J or more, such as 200 J or more, such as 220 J or more, such as 240 J or more, such as 260 J or more, such as 280 J or more, such as 300 J or more, such as 320 J or more, such as 340 J or more, such as 360 J or more, such as 380 J or more. The impact resistance may be 500 J or less, such as 460 J or less, such as 430 J or less, such as 410 J or less, such as 400 J or less, such as 390 J or less, such as 370 J or less, such as 350 J or less, such as 330 J or less, such as 300 J or less, such as 280 J or less, such as 250 J or less, such as 230 J or less, such as 180 J or less. In this regard, in one embodiment, the board may have a classification of 1, a classification of 2, or a classification of 3 for the soft body impact test. Also, in accordance with a hard body impact test, the impact resistance may be 50 J or more, such as 60 J or more, such as 70 J or more, such as 80 J or more, such as 100 J or more, such as 120 J or more, such as 140 J or more, such as 160 J or more, such as 180 J or more, such as 200 J or more, such as 220 J or more. The impact resistance may be 300 J or less, such as 260 J or less, such as 220 J or less, such as 210 J or less, such as 200 J or less, such as 190 J or less, such as 170 J or less, such as 150 J or less, such as 130 J or less, such as 100 J or less. In this regard, in one embodiment, the board may have a classification of 1, a classification of 2, or a classification of 3 for the hard body impact test. Such impact resistance may be based upon the thickness of the cementitious board. For instance, when conducting a test, such impact resistance values may vary depending on the core density, additives, and calcination of the cementitious board. As an example, the impact resistance values above may be for a ⅝ inch board. However, it should be understood that instead of a ⅝ inch board, such impact resistance values may be for any other thickness cementitious board as mentioned herein.

### EXAMPLES

### Test Methods

Decay Time: The decay time may be determined using Adobe Audition software by Adobe Systems. In particular, nominal 12″ by 12″ samples may be suspended on a wire and impacted on one side with consistent force using a hammer with an accelerometer affixed to the opposite side from the point of impact. The decay time may be determined through the software interface by denoting the period between the initial time of impact with the sample and the time when the amplitude of the sound signal approaches zero. The average of three tests may be used to report the sample decay time.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1-32. (canceled)

33. A gypsum board comprising:
a gypsum core including a first gypsum core layer and a second gypsum core layer sandwiching a laminate layer, the laminate layer comprising two outer laminate layers sandwiching an inner laminate layer, wherein the two outer laminate layers have a higher elastic modulus than the inner laminate layer.

34. The gypsum board of claim 33, wherein at least one of the two outer laminate layers has an elastic modulus of from 30 GPa to 500 GPa.

35. The gypsum board of claim 33, wherein at least one of the two outer laminate layers has an elastic modulus of from 0.001 GPa to 15 GPa.

36. The gypsum board of claim 33, wherein the inner laminate layer has an elastic modulus of from 0.0001 GPa to 30 GPa.

37. The gypsum board of claim 33, wherein a ratio of the elastic modulus of the inner laminate layer to the at least one of the two outer laminate layers is from 0.000001 to 1.

38. The gypsum board of claim 33, wherein at least one of the two outer laminate layers is formed from a metal or an alloy thereof, a silicon-based glass, or a carbon fiber reinforced plastic.

39. The gypsum board of claim 33, wherein at least one of the two outer laminate layers is formed from a metal or an alloy thereof comprising bronze, brass, titanium, copper, iron, steel, and/or tungsten.

40. The gypsum board of claim 33, wherein at least one of the two outer laminate layers is formed from aluminum or an alloy thereof.

41. The gypsum board of claim 33, wherein at least one of the two outer laminate layers is formed from a cellulosic material.

42. The gypsum board of claim 33, wherein the inner laminate layer comprises a thermoplastic polymer or a thermoset polymer.

43. The gypsum board of claim 33, wherein the inner laminate layer comprises an acrylic or acrylate polymer or copolymer.

44. The gypsum board of claim 33, wherein the inner laminate layer comprises a rubber.

45. The gypsum board of claim 33, wherein the inner laminate layer comprises a viscoelastic glue.

46. The gypsum board of claim 33, wherein the inner laminate layer, the outer laminate layer, or both comprise a polymer having a glass transition temperature of 200° C. or less.

47. The gypsum board of claim 33, wherein the inner laminate layer comprises a polymer having a longitudinal shear absorption coefficient of 0.1 dB/cm to 100 dB/cm at 25° C. and 2 MHz.

48. The gypsum board of claim 33, wherein the inner laminate layer comprises a polymer having a longitudinal shear velocity of 500 m/s or more to 5,000 m/s or less at 25° C. and 2 MHz.

49. The gypsum board of claim 33, wherein the inner laminate layer comprises a foam.

50. The gypsum board of claim 33, wherein the laminate layer comprises two intermediate laminate layers sandwiching the inner laminate layer and two outer laminate layers sandwiching the intermediate laminate layers and the inner laminate layer.

51. The gypsum board of claim 33, wherein the gypsum board includes an additional laminate layer provided on a face of the gypsum core.

52. The gypsum board of claim 33, wherein the gypsum board exhibits an STC rating of 30 or more as determined in accordance with ASTM E90.

53. The gypsum board of claim 33, wherein the gypsum board exhibits a sound transmission loss of 55 dB or more at a frequency of 1000 Hz.

54. The gypsum board of claim 33, wherein the gypsum board exhibits a sound transmission loss of 50 dB or more at a frequency of 2000 Hz.

55. The gypsum board of claim 33, wherein the gypsum board exhibits a sound transmission loss of 52 dB or more at a frequency of 4000 Hz.

56. A method of making a gypsum board, the method comprising:
providing a first facing material,
depositing a first gypsum slurry onto the first facing material,
providing a laminate layer onto the first gypsum slurry,
depositing a second gypsum slurry onto the laminate layer,
providing a second facing material onto the second gypsum slurry, and
allowing the calcium sulfate hemihydrate to react with the water to convert the calcium sulfate hemihydrate into a matrix of calcium sulfate dihydrate.

57. A gypsum board comprising:
a gypsum core including a first gypsum core layer and a laminate layer on the first gypsum core layer, the laminate layer comprising two outer laminate layers sandwiching an inner laminate layer, wherein the two outer laminate layers have a higher elastic modulus than the inner laminate layer.
